(19) United States
(12) Patent Application Publication
(10) Pub. No.: US 2004/0100559 A1
(43) Pub. Date: May 27, 2004

(54) Camera, camera system and method of operating same

(76) Inventors: Horst Stacklies, Aalen (DE); Franz Graser, Aalen (DE); Alexander Hinz, Koenigsbronn (DE)

Correspondence Address: HOLLAND & KNIGHT, LLP, ONE EAST BROWARD BLVD., SUITE 1300, FT LAUDERDALE, FL, 33301

(21) Appl. No.: 10/645,172

(22) Filed: Aug. 21, 2003

(30) Foreign Application Priority Data
Aug. 23, 2002 (DE) 102 39 523.3

(51) Int. Cl. H04N 5/225

(52) U.S. Cl. 348/207.99

(57) ABSTRACT

A device for resetting the CCD sensor unit 3 is provided for a camera comprising a CCD sensor unit 4 and a shutter 3 in the imaging beam path. This device for resetting the CCD sensor unit 3 comprises a control unit 5 which resets the CCD sensor unit with a time delay and/or with time monitoring after the opening of the shutter. Two or more such cameras can be combined to form a camera system for recording images which are matched to one another in time. A method is specified for operation of a camera and a camera system, in which the CCD sensor unit is in this case reset after opening of a mechanical shutter 3 in the imaging beam path.

### PRIORITY CLAIM

Priority under 35 U.S.C. §119 is hereby claimed to German patent application serial number 102 39 523.3 filed on Aug. 23, 2002.

### BACKGROUND OF THE INVENTION

1. Field of the Invention

The invention relates to the field of photography. More particularly, the invention relates to a camera having a CCD sensor unit, having a shutter in the imaging beam path, and having a device for resetting the CCD sensor unit, and to a camera system in which at least one first camera of this type and one second camera of this type are provided. The invention also relates to a method for operation of a camera having a CCD sensor unit and having a shutter in the imaging beam path, and to a method for operation of a camera arrangement which has at least one first camera with a CCD sensor unit and a shutter in the imaging beam path, and has a second camera with a CCD sensor unit and a shutter in the imaging beam path.

2. Background

A camera having a CCD sensor unit and a shutter in the imaging beam path is known from EP 0 129 122 B1. This document describes a CCD camera with a CCD sensor unit which can be operated in a search mode and an image storage mode. In the search mode, the image of an object area is produced by means of a lens on a subarea of the CCD sensor unit with the shutter open. This image is read continuously from the CCD sensor unit and is displayed to a viewer on a display. In order to store an image which is currently being viewed by an observer in the search mode, the shutter is closed and the CCD sensor unit is read to a memory medium.

Mechanical shutters in particular are known as shutters in cameras, for example focal plane shutters or central shutters. For example, DE 198 34 761 Al describes a mechanical shutter in which a shutter opening can be adjusted by means of plates with which an electrical drive is for this purpose associated. DE 198 32 244 A1 discloses an electromagnetically driven focal plane shutter for a camera.

In addition to mechanical shutters, camera shutters exist based on liquid crystals. Nonmechanical shutters such as these can admittedly be operated comparatively quickly. However, in comparison to mechanical shutters, they transmit relatively little light and have relatively little capability to shut out the light. Camera shutters based on liquid crystals are therefore not highly suitable for use in high resolution cameras.

In order to achieve the maximum image resolution with CCD cameras, what is referred to as a full-frame CCD sensor is used as the CCD sensor unit. With this type of CCD sensor, the light-sensitive transducer elements are used not only for recording the actual image but also for transporting charge during the reading process. Full-frame CCD sensors have a comparatively large image area and allow an image resolution of more than 4 million pixels on an area of a few square centimeters. The time for reading the image information from an image recorded using a sensor such as this is, however, about 0.5 seconds. It is therefore many times longer than the desired exposure time. It is therefore necessary to mask out a CCD sensor unit with a full-frame CCD sensor such as this during the reading process, in order to prevent a detected image from being smeared or blurred.

In order to ensure high light transmission with a good capability to shut out the light at the same time, mechanical shutters are used in a camera in order to mask out the CCD sensor unit for the reading process.

In principle, mechanical shutters can admittedly be closed precisely in a time scale of a few milliseconds. However, the opening of a mechanical shutter cannot be controlled so exactly since the components which are moved quickly during this process result in mechanical oscillations whose time scale may last for several tens of milliseconds. It has therefore been found to be impossible to precisely define the time at which a mechanical shutter opens with millisecond accuracy. Furthermore, the oscillations which occur during opening of such a shutter cause brightness fluctuations in a recorded image.

### SUMMARY OF THE INVENTION

Accordingly, it is an object of the invention to provide a high resolution camera having a CCD sensor unit, in which it is possible, even when using a mechanical shutter, to set a recording time for an image with an accuracy which is considerably shorter than the order of magnitude of milliseconds, preferably in the region of 100 microseconds, and to provide a method for operation of a camera having a CCD sensor unit, by means of which the time for recording an image can be defined in a time scale of milliseconds.

A preferred embodiment of a camera according to the invention includes a CCD sensor unit, a shutter in the imaging beam path and a device for resetting the CCD sensor unit. The device for resetting the CCD sensor unit comprises a control unit coupled to the CCD sensor unit and causing the CCD sensor unit to be reset after opening of said shutter.

The solution according to the invention results in a camera in which oscillation processes which occur during the opening of a mechanical shutter do not affect the recording of the image.

According to a method of the invention for operation of a camera, a shutter is opened, and a CCD sensor unit is reset after the shutter has been opened.

In this way, the time for recording an image can be set accurately to a few microseconds, namely to the same time scale as the response of a CCD chip.

In a preferred embodiment of the invention, the control unit includes a time monitoring circuit. Since the precise time at which the CCD sensor unit is reset is related to the time at which the shutter is opened, that is to say to the time at which it starts to open, it is possible to ensure that the light transmission through the shutter does not fluctuate in the course of recording an image when using mechanical shutters. If the time for resetting is defined absolutely, then the precise time for recording an image can be defined exactly. This is of particular interest for airborne photography and for PIN-point photography.

In a further embodiment of the invention, a piezoelectric or electromagnetic drive is provided for the shutter. This results in a robust and reliable drive for the camera.

A camera arrangement having cameras whose image recording times are matched to one another is provided, by combining at least one first camera having a CCD sensor unit, a device for resetting the sensor unit and a shutter in the imaging beam path with a second such camera, with time monitoring control being provided to allow each CCD sensor unit to be reset at a defined time.

Since the shutter of the first camera and the shutter of the second camera are opened in such a camera arrangement, and the CCD sensor unit in the first camera and that in the sensor camera are then reset, this allows a large area of the ground to be covered by synchronous recording of different object areas for airborne photography. A camera arrangement such as this then also allows good color resolution for synchronous recording of different color channels. In this case, the appropriate CCD sensor units can be reset at the same time, that is to say synchronously, or, if desired, at different times. Resetting a CCD sensor unit at a specific time makes it possible, for example, to reference an accurate recording time with the movement of an airborne vehicle.

Preferred embodiments of the invention will be described in more detail in the following text and are illustrated in the drawings:

### BRIEF DESCRIPTION OF THE DRAWINGS

FIG. 1 shows a camera having a CCD sensor unit;

FIG. 2 illustrates the light transmission, I, through the mechanical shutter as a function of time and the advantageous time for a reset signal for a CCD sensor unit; and

FIG. 3 shows a camera arrangement for synchronized image recording.

### DETAILED DESCRIPTION

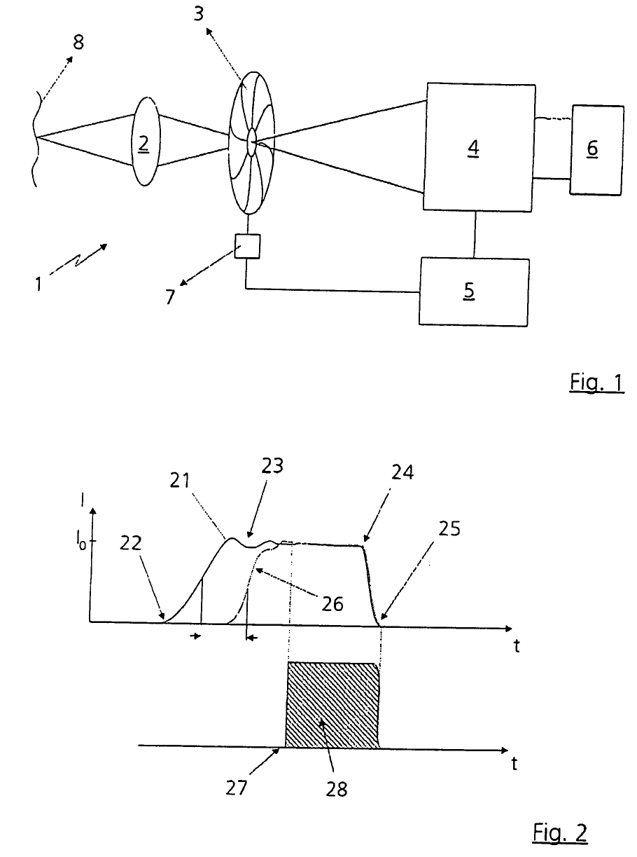

FIG. 1 shows a camera 1 with an objective lens 2. The camera also has a mechanical shutter 3, which can open and close a beam path from an object area 8 to a CCD sensor unit 4, in the preferred embodiment, which is in the form of a full-frame CCD sensor. The CCD sensor unit 4 has an associated control unit 5, by means of which the resetting of the CCD sensor unit 4 can be adjusted, and which results in the CCD sensor unit 4 being read to an electronic memory 6.

The control unit 5 is connected to a piezoelectric control element 7 which drives the mechanical shutter 3 so that it can be opened and closed using signals from the control unit 5.

The method of operation of the camera 1 shown in FIG. 1 will be explained with reference to FIG. 2, in which the solid line 21 shows the light transmission, I, which is proportional to the opening area of the shutter 3 shown in FIG. 1, as a function of time. When the control unit 5 passes a signal to the piezoelectric control element 7 to open the shutter 3 at a time 22, then the light transmission, I, increases in a time scale of about ten (10) milliseconds and has a characteristic transient response in an area 23. The reason for this oscillatory response is the elasticity of the components used for the mechanical shutter, their inertia, as well as friction and bearing play. Once the oscillatory response has decayed, the light transmission of the shutter has a desired value I₀. This value can also be adjusted very accurately when a mechanical shutter is used and virtually does not vary at all in terms of manufacturing tolerances. If the control unit 5 emits a signal to close the shutter 3 from FIG. 1 to the control element 7 at the time 24, then the light transmission of the shutter decreases from a selected value to the value zero at the time 25.

The order of magnitude of the duration of the shutter closing process is in the region of milliseconds.

Wear and manufacturing tolerances for a mechanical shutter mean that its opening time can be set accurately only on a time scale on the order of about ten (10) milliseconds. The curve 26 in FIG. 2 shows the opening response of a shutter which corresponds to the shutter 3 shown in FIG. 1 and which is driven in the same way. The time to reach the desired light transmission I₀ and the oscillatory response that occurs during the opening process are different. However, this shows that the closing process is identical, on a time scale of about one (1) millisecond, despite this different opening response of mechanical shutters.

The control unit 5 shown in FIG. 1 acts as a delay circuit. Once the transient response of the shutter 3 resulting from it being opened has decayed, the control unit 5 produces a reset signal 9 to the CCD sensor unit at a time which substantially coincides with the time 27. This results in all the light-sensitive pixels of this sensor 4 being set to the same state. The time scale for producing this reset state is in the region of microseconds. The process of carrying out a reset once the transient response of an opened shutter has decayed thus makes it possible to set the time for starting to record an image with a CCD sensor to a degree of precision which can be more than four orders of magnitude better than is possible by operation of a mechanical shutter.

The exposure process of the CCD sensor unit 4 shown in FIG. 1 is interrupted by closing the mechanical shutter 3. The closing process is initiated by a control signal from the control unit 5. Despite manufacturing tolerances, friction and the elasticity of components, the mechanical shutter 3 can be closed in a time scale of one millisecond, that is to say it is possible within this time scale to reduce the light transmission, I, of the open shutter to a value which is less than 10% of the value when it is open. Light flux as indicated by the shaded area 28 in FIG. 2 can thus be kept constant with accuracy while the camera 1 is being used to record an image.

For a modified embodiment of the camera as shown in FIG. 1, a time monitoring circuit is provided in the control unit 5. This time monitoring circuit on the one hand makes it possible to monitor the time interval between a signal, which is emitted from the control unit to an actuating unit, to open the shutter in the region of 10⁻⁶ seconds, and on the other hand makes it possible to define the absolute time for a reset signal, which is emitted from the control unit to the CCD sensor unit, on this time scale. In particular, this allows exact synchronization of two or more cameras, as is required in particular for airborne photography, in particular for PIN-point photography.

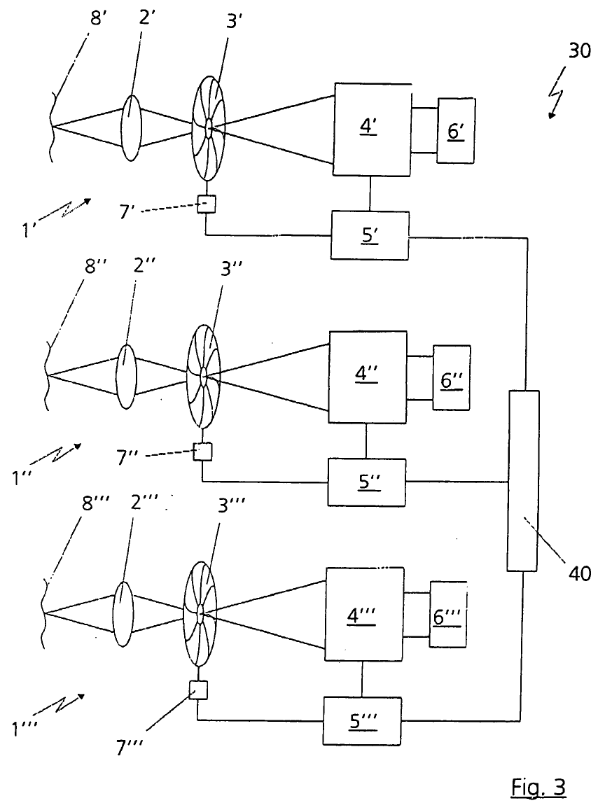

FIG. 3 shows a camera system 30 which is particularly suitable for airborne photography and comprises a number of cameras 1′, 1″ and 1′″, each of which corresponds to the camera 1 shown in FIG. 1, and in which assemblies corresponding to those associated with the camera 1 shown in FIG. 1 are shown, with appropriate prime symbols after the corresponding reference numerals.

The cameras 1′, 1″ and 1′″, as shown in FIG. 3, are combined with one another for time-monitored triggering. For synchronized image recording with the cameras, a monitoring unit 40 emits a control command to the control units 5′, 5″ and 5′″, which causes the shutters 3′, 3″ and 3′″ to be opened, with the CCD sensor units 4′, 4″ and 4′″ being reset synchronously after a defined time interval. In order to end the exposure of the CCD sensor units 4′, 4″ and 4′″ at a desired time, the monitoring unit 40 then outputs a control command to close the shutters to the control units 5′, 5″ and 5′″, in response to which these control units operate the actuating units 7′, 7″ and 7′″ in an appropriate manner. The CCD sensor units 4′, 4″ and 4′″ are each read to a respective electronic memory 6′, 6″ and 6′″ to capture an image.

Instead of exactly synchronizing the timing of an image recording with 3 cameras, it is also possible to provide time windows at exactly defined times but shifted with respect to one another for image recording.

While FIG. 3 shows the use of three cameras 1′, 1″, and 1′′, there is, of course, in principle no restriction to the number of cameras in a camera system such as this. Cameras which operate in parallel are thus particularly advantageous for airborne photography.

Instead of providing a piezoelectric drive for opening and closing the shutter in the described cameras 1, 1′, 1″ and/or 1′″, it is, of course, also possible for them to be driven electromagnetically or in any other suitable form.

What is claimed is:

1. A camera, comprising: a CCD sensor unit, a shutter in an imaging beam path of said CCD sensor unit, and a reset device for resetting said CCD sensor unit, said reset device having a control unit coupled to said CCD sensor unit for causing said CCD sensor unit to be reset after opening of said shutter.

2. A camera as claimed in claim 1, wherein said control unit further includes a time monitoring circuit for causing the CCD sensor unit to be reset at a defined time.

3. A camera as claimed in claim 2, wherein said defined time is a time related to an opening time of said shutter.

4. A camera as claimed in claim 2, wherein said defined time is a time which is defined absolutely.

5. A camera as claimed in one of claim 1, wherein said shutter is driven by one of, a piezoelectric and electromagnetic drive.

6. A camera system comprising: at least two cameras, each of said cameras including (i) a CCD sensor unit, (ii) a reset device for resetting said sensor unit, (iii) a shutter in an imaging beam path of each said respective CCD sensor unit, and (iv) a monitoring unit for providing commands for initiating opening of said shutter and for causing said reset device to reset said sensor unit.

7. A camera system as claimed in claim 6, wherein at least said reset device of one of said cameras includes a control unit coupled to said CCD sensor unit for causing said CCD sensor unit to be reset after opening of said shutter.

8. A method for operating a camera, said method comprising the steps of: opening a shutter of the camera, and, resetting a CCD sensor unit of the camera after said opening of said shutter.

9. A method for operation of a camera system having at least one first camera and one second camera, said method comprising the steps of: (a) opening a shutter of the first camera, (b) opening a shutter of the second camera, and (c) resetting a CCD sensor unit of the first camera and a CCD sensor unit of the second camera after said shutters of said first camera and said second camera have opened.

10. A method as claimed in claim 9, wherein said CCD sensor unit of the first camera and said CCD sensor unit for the second camera are both reset at substantially the same time.

11. A method as claimed in claim 9, wherein said CCD sensor unit for the first camera and said CCD sensor unit for the second camera are each reset at different times.

12. The method as claimed in claim 9, wherein at least one of said CCD sensor unit for said first camera and said CCD sensor unit for said second camera is reset at a defined time.

13. A photography method, comprising the steps of:
(a) providing a camera having a CCD sensor unit, a shutter in an imaging beam path of said sensor unit, and a device for resetting said sensor unit, said reset device having a control unit coupled to said sensor unit for causing said sensor unit to be reset after opening of said shutter;
(b) opening said shutter, and
(c) resetting said image sensor after said opening of said shutter.

14. The method of claim 13 further, comprising the step of:
(a) performing said resetting step based on a transient response of said shutter.

15. A photography method, comprising the steps of:
(a) providing a camera system having at least two cameras, including a first camera and a second camera, said first camera having a first shutter and a first CCD sensor unit in an imaging beam path of said first shutter, said second camera having a second shutter and a second CCD sensor unit in an imaging beam path of said second shutter;
(b) opening said first shutter;
(c) opening said second shutter, and;
(d) resetting said first sensor unit and said second sensor unit after said first shutter and said second shutter both have opened.

16. The method of claim 15 further comprising the step of:
(a) performing said resetting step based on a transient response of said shutter.

17. The method of claim 15 wherein said resetting step comprises the step of resetting said first sensor unit and said second sensor unit substantially synchronously.

18. The method of claim 16 wherein said resetting step comprises the step of resetting said first sensor unit and said second sensor unit substantially synchronously.
